(19) United States
(12) Patent Application Publication
(10) Pub. No.: US 2025/0261653 A1
(43) Pub. Date: Aug. 21, 2025

(54) Dough Proofing Retarder Comprising Means for Discharging Moisture

(71) Applicant: TURBO KOREA Corporation, Gwangju (KR)

(72) Inventor: Chang Hun Park, Gwangju (KR)

(21) Appl. No.: 19/035,182

(22) Filed: Jan. 23, 2025

(30) Foreign Application Priority Data
Feb. 19, 2024 (KR) 10-2024-0023764

(51) Int. Cl. A21C 13/00; A21C 14/00

(52) U.S. Cl. CPC A21C 13/00; A21C 14/00

(57) ABSTRACT

The present invention relates to a dough proofing retarder comprising means for discharging moisture, which includes a main body, a temperature maintenance part, a water injection part, a circulation fan motor, and a moisture discharge part, which is installed on one side surface of the main body, and configured to discharge moisture in the fermentation space to an outside environment. Accordingly, the time that moisture remains in the fermentation space can be significantly reduced, preventing the decline in the commodity value of fermented foods and eliminating the need to operate a radiator that consumes high electric energy to remove moisture.

### CROSS REFERENCE TO RELATED APPLICATION OF THE DISCLOSURE

The present application claims the benefit of Korean Patent Application No. 10-2024-0023764 filed in the Korean Intellectual Property Office on Feb. 19, 2024, the entire contents of which are incorporated herein by reference.

### BACKGROUND OF THE DISCLOSURE

### Field of the Disclosure

The present invention relates to a dough proofing retarder comprising means for discharging moisture and, more specifically, to a dough proofing retarder comprising means for discharging moisture, which can rapidly discharge moisture generated inside a main body to the outside when the moisture rapidly increases during a fermentation process, thereby preventing the inside and outside of a fermented food from becoming too much soft and reducing its marketability.

### Background of the Related Art

In general, bread is made by mixing a certain amount of water with wheat flour, kneading the dough, fermenting it, and then baking or steaming it. To make bread, the main ingredients such as wheat flour, yeast, salt, and water are mixed with various auxiliary ingredients such as sugar, eggs, and cooking oil, selectively depending on the type of bread to be made, so as to make bread dough. The dough is then put into a fermentation device, fermented, and then baked or steamed.

Conventional bread fermenters are structured to heat water stored in a water tank installed on a lower side of a main body with a door so as to generate steam, and has been used to ferment bread dough by controlling the temperature and humidity inside the main body. However, the conventional bread fermenters have a problem in that the steam generated by heating in the water tank installed on the bottom of the main body is not evenly distributed upward and downward, but is concentrated on a lower side, so the bread dough arranged on each shelf disposed in multiple stages inside the main body is not fermented evenly.

Accordingly, in order to solve the above problem, an electric heater has been installed inside the main body of the fermenter in recent years so that the inside of the main body can be heated to a warm temperature suitable for fermenting raw materials or general fermentation foods, and at the same time, water is sprayed at regular intervals from a water jet pipe installed above the electric heater toward the heated electric heater, so that the water sprayed onto the electric heater is instantly heated and turns into steam, which then diffuses inside the main body, thereby maintaining a humidity suitable for fermentation.

However, since the conventional fermenter main body has a completely sealed structure, there is no configuration to remove the humidity inside the main body even when the humidity increases excessively more than necessary. Therefore, excessive moisture is supplied to the ingredients of bread dough or the general fermentation foods, which causes the outside and inside of the bread dough or the general fermentation foods to become too much soft during the fermentation process, declining the commodity value. In addition, even after the fermentation process is over, the inside of the device is always in a high humidity state, which causes bacterial growth and corrosion inside the device over time.

In addition, when the moisture generated inside the main body was removed by raising the temperature of the electric heater, it was difficult to maintain uniform quality of the bread dough or the general fermentation foods because pressure increases inside the main body due to the high temperature and the steam. Furthermore, there was also the problem of increased power consumption due to the continuous heating action of the electric heater.

### PRIOR ART DOCUMENT

### Patent Document

(Patent Document 1) Korean Patent Publication 2020-0089372 Jul. 27, 2020)

### SUMMARY OF THE DISCLOSURE

The present invention has been derived to solve the above problems, and a purpose of the present invention is to provide a dough proofing retarder comprising means for discharging moisture, which can rapidly discharge moisture generated inside a main body to the outside when the moisture rapidly increases during a fermentation process.

In addition, another purpose of the present invention is to provide a dough proofing retarder comprising means for discharging moisture, which can quickly remove moisture generated inside a main body after use of the dough proofing retarder, and keeping the inside of the main body hygienic and clean by using outside air.

In order to achieve the above-mentioned purposes, a dough proofing retarder comprising means for discharging moisture according to the present invention includes a main body, which has an interior divided into a fermentation space and a machine room, and is provided with an opening/closing door on a front part thereof, a temperature maintenance part, which is installed in the machine room of the main body and controls temperature of the fermentation space, a water injection part, which is installed in the machine room of the main body and generates moisture necessary for the fermentation space, a circulation fan motor, which is installed in the machine room of the main body and supplies heat and moisture to the fermentation space, and a moisture discharge part, which is installed on one side surface of the main body and discharges moisture in the fermentation space to the outside.

The moisture discharge part includes a frame, which is installed on the main body and has a through hole communicating with an open hole formed in the one side surface of the main body, a frame door for opening/closing the through hole of the frame, a stepping motor, which has a rotation shaft coupled to the frame door and rotates the rotation shaft, and a ventilation fan installed in the open hole.

The frame door includes a main plate and an elastic rib, which is installed around a perimeter of the main plate and comes into close elastic contact with the frame.

The moisture discharge part is installed at a rear surface of the main body, which faces the opening/closing door, and includes a first passing part for discharging moisture from the fermentation space to the outside, and a second passing part for supplying outside air to the fermentation space.

The main body is equipped with a filter frame, which safely covers and protects the moisture discharge part that is exposed to the outside and primarily filters out foreign substances that enter with the outside air.

The main body is provided with an outside air intake duct for connecting the machine room and the filter frame.

Inside the main body, a humidity sensor and a temperature sensor are installed to measure humidity and temperature, and a control unit is installed to operate the stepping motor and the ventilation fan by using humidity and temperature detected by the humidity sensor and the temperature sensor.

### BRIEF DESCRIPTION OF THE DRAWINGS

FIG. 1 is a perspective view showing a dough proofing retarder comprising means for discharging moisture according to an embodiment of the present invention.

FIG. 2 is a rear perspective view of FIG. 1.

FIG. 3 is a side cross-sectional view of FIG. 1.

FIG. 4 is an exploded perspective view showing a filter frame and an outside air intake duct in FIG. 2.

FIG. 5 is a perspective view showing the configuration of a moisture discharge part of FIG. 2.

FIG. 6A is a view showing a frame door of the moisture discharge part of FIG. 2 in an open state.

FIG. 6B is a view showing a frame door of the moisture discharge part of FIG. 2 in a closed state.

FIG. 7 is an enlarged view showing intake and exhaust operations of the moisture discharge part of FIG. 2.

### DETAILED DESCRIPTION OF THE PREFERRED EMBODIMENT

Hereinafter, preferred embodiments of a dough proofing retarder equipped with a moisture discharge part according to the present invention will be described in detail with reference to the accompanying drawings.

For reference, the terms and words used in this specification and claims should not be interpreted as limited to their usual or dictionary meanings, and should be interpreted as meanings and concepts that conform to the technical idea of the present invention based on the principle that the inventor can appropriately define the concept of the term in order to explain his own invention in the best way.

In addition, the embodiments described in this specification and the configurations illustrated in the drawings are only the most preferred embodiments of the present invention, and do not represent all the technical ideas of the present invention, so it should be understood that various equivalents and modified examples that can replace them may exist not only at the time of filing this application but also thereafter.

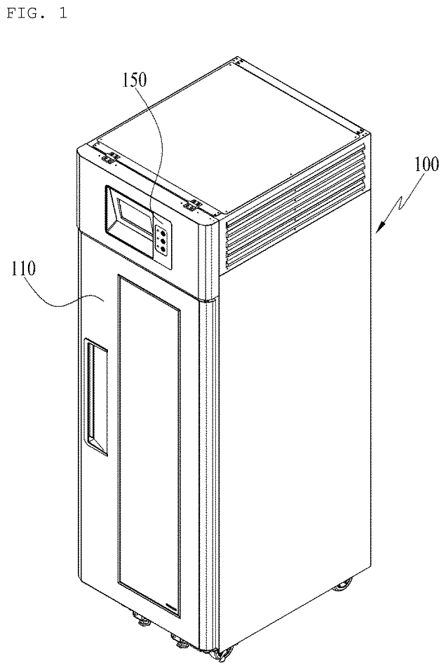

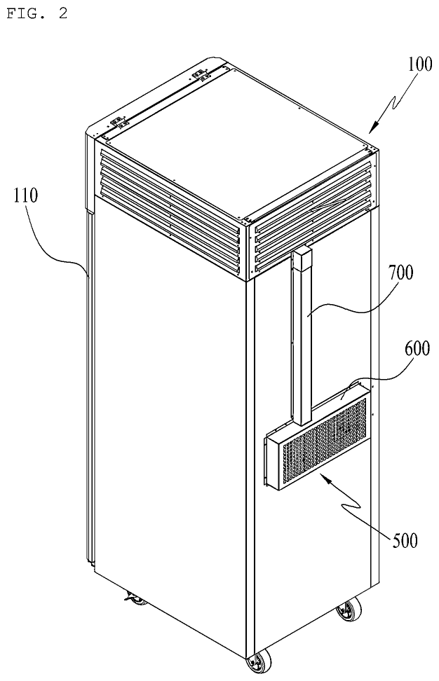

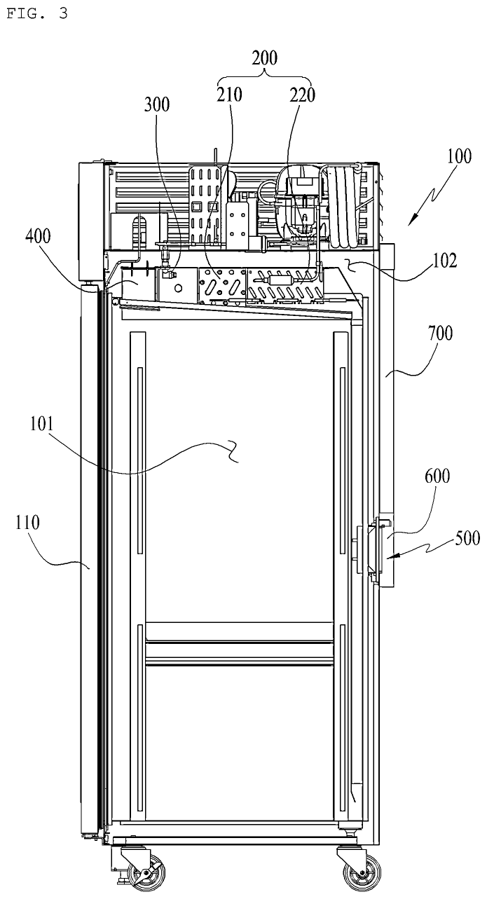

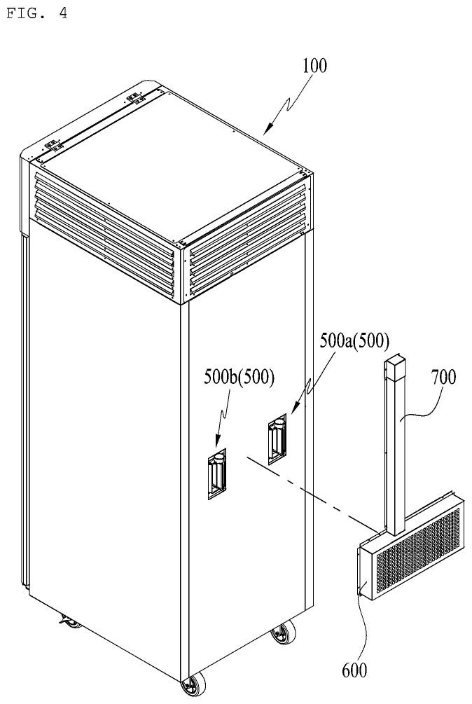

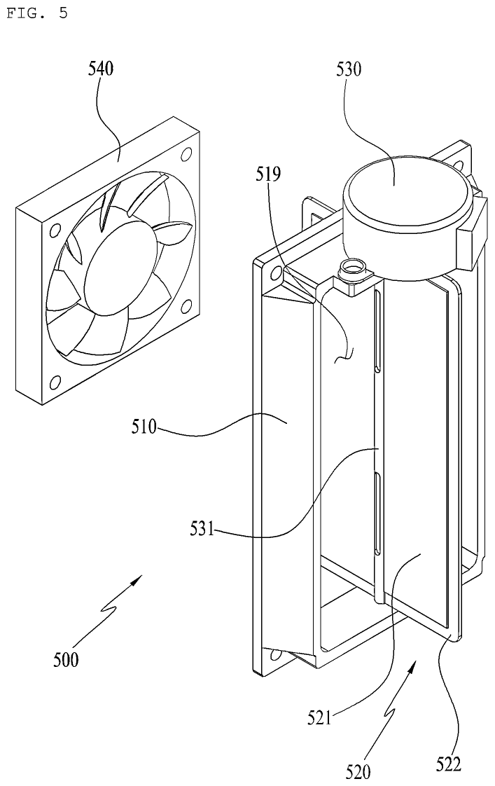

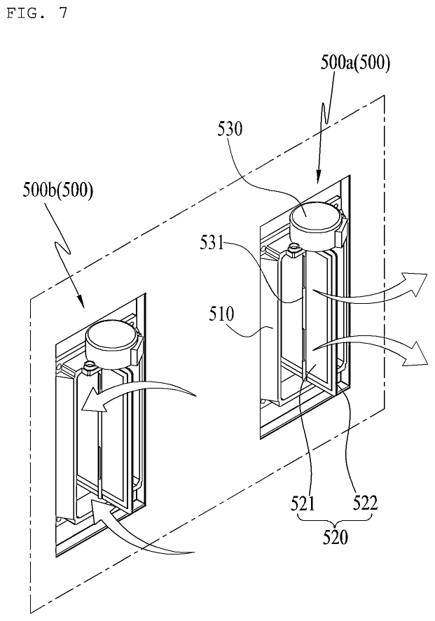

Hereinafter, preferred embodiments of the present invention will be described in detail with reference to the accompanying drawings, FIG. 1 to FIG. 7.

As shown, a dough proofing retarder comprising means for discharging moisture according to the present invention includes a main body 100, which has an interior divided into a fermentation space 101 and a machine room 102 and is provided with an opening/closing door 110 on the front part thereof, a temperature maintenance part 200, which is installed in the machine room 102 of the main body 100 and controls temperature of the fermentation space 101, a water injection part 300, which is installed in the machine room 102 of the main body 100 and generates moisture necessary for the fermentation space, a circulation fan motor 400, which is installed in the machine room 102 of the main body 100 and supplies heat and moisture to the fermentation space, and a moisture discharge part 500, which is installed on one side surface of the main body 100 and discharges moisture from the fermentation space 101 to the outside (i.e., an outside environment).

First, the main body 100 is formed in a box shape with the interior divided into the fermentation space 101 and the machine room 102, and the opening/closing door 110 for opening or closing the fermentation space is installed on the front side where the fermentation space 101 is located.

It is preferable to form the machine room 102 in an upper part of the main body 100 and the fermentation space 101 in a lower part thereof.

The temperature maintenance part 200 is installed in the machine room 102 of the main body 100, and serves to maintain a temperature suitable for fermentation of raw materials or fermentation foods fed into the fermentation space 101.

The temperature maintenance part 200 is composed of a radiator 210 that warms air by emitting heat of steam or hot water, and a cooler 220 that lowers the temperature.

The water injection part 300 is installed in the machine room of the main body 100 and serves to generate moisture required for a fermentation process occurring in the fermentation space 101.

That is, the water injection part 300 directly injects water into the radiator 210 in a heated state so as to change the water into steam, thereby providing appropriate humidity for fermentation of raw dough or fermentation of food inside the fermentation space 101.

In addition, a control unit 150 is installed on the front of the main body 100 so as to control on/off operations of the temperature maintenance part 200, the water injection part 300, and the circulation fan motor 400, which will be described hereinafter. A display unit is formed in the control unit 150 so as to indicate temperature and humidity of the fermentation space 101, and a temperature sensor and a humidity sensor are installed in the fermentation space 101 so as to detect internal temperature and humidity, respectively.

The circulation fan motor 400 is installed in the machine room 102 of the main body 100 and serves to blow heat and moisture generated inside the machine room 102 to the fermentation space 101.

That is, the circulation fan motor 400 introduces heat and moisture through an inlet at one side, and thus introduced heat and moisture are discharged into the fermentation space 101 through an outlet at the other side.

Hereinafter, the moisture discharge part 500, which is a characteristic component of the present invention, will be described in detail.

The moisture discharge part 500 is installed on one side surface of the main body 100, and serves to quickly discharge moisture from the inside of the fermentation space 101 to the outside environment, and to allow the inside of the fermentation space 101 to be air-cleaned using outside air, thereby allowing the inside of the fermentation space 101 to be managed hygienically and cleanly.

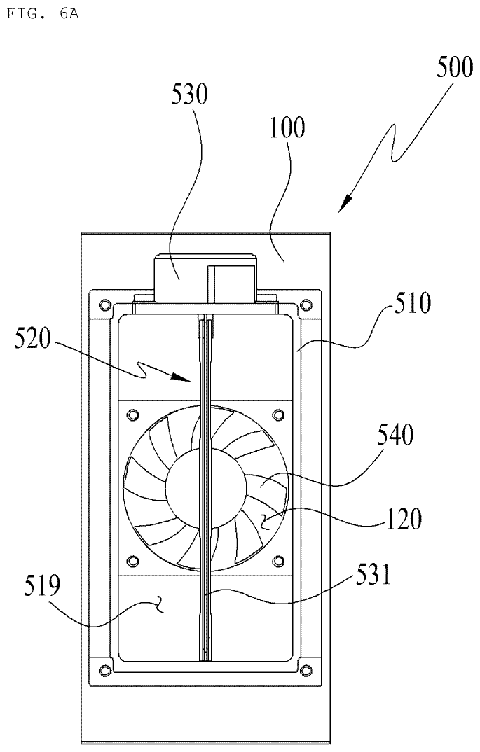

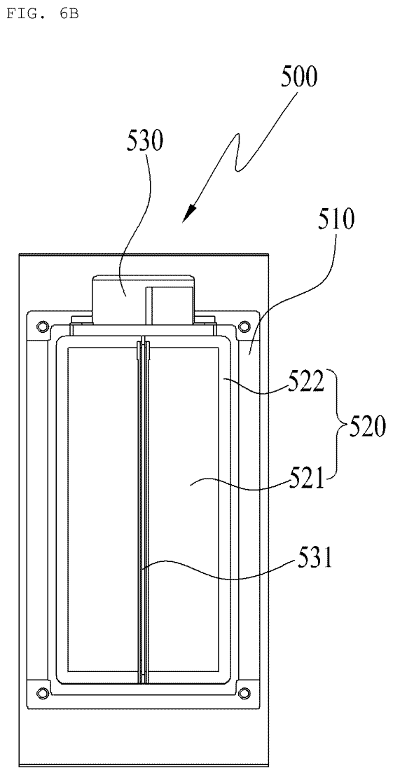

Specifically, as shown in FIG. 6A and 6B, the moisture discharge part 500 includes a frame 510, which is installed on the main body 100 and has a through hole 519 communicating with an open hole 120 formed in one side surface of the main body 100, a frame door 520 for opening and/or closing the open through hole 519 of the frame 510, a stepping motor 530, which has a rotation shaft 531 coupled to the frame door 520 and rotates the rotation shaft 531, and a ventilation fan 540 installed in the open hole 120.

That is, when moisture supplied to the fermentation space 101 increases significantly above a set value, the stepping motor 530 rotates and opens the frame door 520 that blocks the open hole 120 and, at the same time, the ventilation fan 540 operates to rapidly discharge the moisture inside the fermentation space 101 to the outside, so that the moisture discharge part 500 can rapidly discharge an appropriately large amount of moisture to the outside, thereby significantly reducing the time that the moisture remains in the fermentation space 101 and preventing a decline in the commodity value of fermented food.

In addition, the frame door 520 is composed of a main plate 521 and an elastic rib 522 that is installed around the perimeter of the main plate 521 and comes into close elastic contact with the frame 510.

That is, since the elastic rib 522 is in close contact with an inner surface of the through hole 519 of the frame 510, when the frame door 520 is in a closed state blocking the through hole 519 of the frame 510, the elastic rib 522 has the advantage of completely filling a gap so as to prevent flow of internal and external air and effectively prevent foreign substances from penetrating from the outside. In this sense, the elastic rib 522 acts as a gasket or a seal.

The moisture discharge part 500 according to the present invention is installed on a rear surface of the main body 100, facing the opening/closing door 110, and is preferably composed of a first passing part 500a for discharging moisture from the fermentation space 101 to the outside and a second passing part 500b for supplying outside air to the fermentation space.

That is, the first passing part 500a serves to discharge moisture inside the fermentation space 101 to the outside, and the second passing part 500b serves to supply outside air to the fermentation space 101.

Accordingly, moisture inside the main body 100 can be quickly removed, and fresh air from the outside can be supplied to the inside of the main body 100 at any time, thereby preventing the growth of bacteria or mold and enabling continuous cleanliness management.

In addition, it is preferable that the ventilation fan 540 is configured to operate automatically when the stepping motor 530 is driven to rotate the frame door 520 and open the through hole 519 of the frame 510 so that moisture is removed quickly.

That is, it is preferable to perform automatic control in such a way that when removing moisture inside the main body 100, the ventilation fan 540 operates simultaneously with the stepping motor 530, and when moisture removal is not necessary, the stepping motor 530 rotates in an opposite direction or additionally rotates in a same direction so that the through hole 519 of the frame 510 is closed by the frame door 520, and the ventilation fan 540 stops operating.

To this end, the humidity sensor and the temperature sensor (not shown) for respectively measuring humidity and temperature are installed in the main body 100, and the control unit (not shown) is installed to operate the stepping motor 530 and the ventilation fan 540 by using the humidity and temperature detected by the humidity sensor and the temperature sensor.

In one aspect, the control unit can be configured to be connected to the temperature maintenance part 200, the water injection part 300 and the circulation fan motor 400 so as to control operating time and on/off switching of the respective components.

In addition, a filter frame 600 may be installed on the main body 100 so as to cover and safely protect the moisture discharge part 500 that is exposed to the outside environment, and to primarily filter out foreign substances introduced with outside air.

In this case, it is preferable that portions communicating with the first passing part 500a and the second passing part 500b inside the filter frame 600 that faces the moisture discharge part 500 be clearly separated by a partition (not shown) or the like so as to prevent moisture discharged to the outside through the first passing part 500a from directly flowing into the main body 100 through the second passing part 500b.

In addition, it is preferable to additionally install an outside air intake duct 700 that connects the machine room 102 and the filter frame 600 in the main body 100.

This is to supply some of the outside air sucked in during the operation of the second passing part 500b to the machine room 102 so that dust, moisture, heat, etc. accumulated inside the machine room can escape more easily to the outside.

According to the present invention in the configuration described above, the moisture discharge part is provided and discharges moisture within the fermentation space to the outside, so that the time that moisture remains in the fermentation space can be significantly reduced, thereby preventing the decline in the commodity value of fermented foods and eliminating the need to operate a radiator that consumes high electric energy to remove moisture.

In addition, the frame door of the moisture discharge part has the advantage of being equipped with an elastic rib that can perfectly fill a gap through which air and moisture can flow and effectively prevent foreign substances from penetrating from the outside.

In addition, the moisture discharge part includes the first passing part and the second passing part, so that the moisture inside the main body can be quickly removed and the inside of the main body can be maintained clean through air washing using the outside air.

The present invention described above is not limited to the above-described embodiments and the attached drawings, and it will be apparent to a person skilled in the art to which the present invention pertains that various substitutions, modifications, and changes are possible within a scope that does not depart from the technical spirit of the present invention.

What is claimed is:

1. A dough proofing retarder, comprising:
a main body, which has an interior divided into a fermentation space and a machine room, and is provided with an opening or closing door on a front part thereof;
a temperature maintenance part, which is installed in the machine room of the main body, and configured to control a temperature of the fermentation space;
a water injection part, which is installed in the machine room of the main body, and configured to generate moisture necessary for the fermentation space;
a circulation fan motor, which is installed in the machine room of the main body, and configured to transmit heat and moisture to the fermentation space; and
a moisture discharge part, which is installed on one side surface of the main body, and configured to discharge moisture in the fermentation space to an outside environment.

2. The dough proofing retarder according to claim 1, wherein the moisture discharge part includes:
a frame, which is installed on the main body and has a through hole communicating with an open hole formed in the one side surface of the main body;
a frame door for opening or closing the through hole of the frame;
a stepping motor, which has a rotation shaft coupled to the frame door and rotates the rotation shaft; and
a ventilation fan installed in the open hole.

3. The dough proofing retarder according to claim 2, wherein the frame door includes a main plate and an elastic rib, wherein the elastic rib is installed around a perimeter of the main plate and comes into close elastic contact with the frame.

4. The dough proofing retarder according to claim 3, wherein the moisture discharge part is installed at a rear surface of the main body, which faces the opening or closing door, and includes a first passing part for discharging moisture from the fermentation space to the outside environment, and a second passing part for supplying outside air to the fermentation space.

5. The dough proofing retarder according to claim 1, wherein the main body is equipped with a filter frame, which covers and protects the moisture discharge part that is exposed to the outside environment, and primarily filters out foreign substances that enter with outside air.

6. The dough proofing retarder according to claim 5, wherein the main body is provided with an outside air intake duct for connecting the machine room and the filter frame.

7. The dough proofing retarder according to claim 2, wherein inside the main body, a humidity sensor and a temperature sensor are installed to measure a humidity and a temperature, respectively, wherein the humidity and the temperature are measured inside the main body, and a control unit is installed to operate the stepping motor and the ventilation fan by using the humidity and the temperature measured by the humidity sensor and the temperature sensor, respectively.
